(19) United States
(12) Patent Application Publication
(10) Pub. No.: US 2012/0308343 A1
(43) Pub. Date: Dec. 6, 2012

(54) Assembly Device

(75) Inventor: Uwe Habisreitinger, Freudenstadt/Dietersweiler (DE)

(73) Assignee: Daimler AG, Stuttgart (DE)

(21) Appl. No.: 13/574,294

(22) PCT Filed: Dec. 4, 2010
(86) PCT No.: PCT/EP10/07376

§ 371 Date: Aug. 22, 2012

(30) Foreign Application Priority Data
Jan. 21, 2010 (DE) 10 2010 005 314.7

(51) Int. Cl. B23P 21/00; B65G 47/90; B25J 5/02

(52) U.S. Cl. 414/222.01; 414/749.1

(57) ABSTRACT

An assembly unit with an industrial robot for handling a vehicle body is provided. The industrial robot can be moved by coupling to the vehicle body in the conveying direction, in which a conveyor belt conveys the vehicle body. The industrial robot retains in any conveying situation its exact position relative to the workpiece in all directions. A transport platform serves to transport the industrial robot. The transport platform can be moved independently of the conveyor belt and without use of rails if the industrial robot is decoupled from the vehicle body. A component storage unit can be coupled to the transport platform. The component storage unit then can also be moved by the transport platform. The industrial robot can be designed for a small load to achieve a cost-effective assembly unit.

### BACKGROUND AND SUMMARY OF THE INVENTION

Exemplary embodiments of the present invention relate to an assembly unit with a handling means for handling a workpiece, in particular a vehicle body. The handling means can be moved in a conveying direction through coupling to the workpiece, in which a conveying means conveys the workpiece. The assembly unit further comprises a transport means for transporting the handling means.

German Patent Document No. DE 10 2006 026 132 A1 describes an assembly system with a conveying path, on which vehicle bodies are conveyed in a conveying direction. In addition to the conveying path, an industrial robot can also be moved on a robot conveying path in the conveying direction. The industrial robot is coupled to the vehicle body while it handles the vehicle body. The industrial robot is mounted so that it floats. By moving the vehicle body the industrial robot is also moved, whereby the floating support allows the industrial robot to follow movements of the vehicle body relative to the conveying path. This provides an entrained assembly system.

Exemplary embodiments of the present invention provide an improved assembly unit of the type mentioned above.

The inventive assembly unit comprises a handling means for handling a workpiece, in particular a vehicle body. The handling means can be a robot that brings components or modules to a vehicle body and/or carries out function tests. The handling means can be moved by coupling to the workpiece in a conveying direction, in which a conveying means conveys the workpiece. Furthermore, the assembly unit comprises a transport means for transporting the handling means. The transport means can be moved independently of the conveying means, and can be moved without use of rails if the handling means is decoupled from the workpiece. Accordingly, this provides an improved assembly unit with a particularly large spatial flexibility of the handling means.

If the conveying means is a conveyor belt the transport means can be moved at the speed of the conveyor belt beside the conveyor belt until the handling means is coupled to the workpiece. After coupling the movement of the conveyor belt the assembly unit moves with the conveyor belt.

As soon as the handling means has carried out the handling steps provided it can be decoupled from the conveying means and brought via the transport means to another place of use. It is thus possible to move to another section of the conveying means for the same or another handling step, for example an assembly operation. After decoupling of the handling means from the workpiece the transport means can also bring the handling means to an equipping station, at which material can be received and transported to the place at which it is to be incorporated.

If the handling means is mounted so as to float on the transport means, speed differences between the conveying means and the transport means can be compensated via relative movements of the handling means relative to the transport means. The handling means is preferably mounted so that it floats on the transport means in all degrees of freedom.

According to a further aspect of the invention an improved assembly unit of the abovementioned type is provided if the transport means comprises a coupling means for coupling at least one component storage unit that can be moved in the coupled state together with the transport means. After the end of a handling step, for example after incorporation of a component, the assembly unit then does not need to be moved back to the component storage unit, as the component storage unit is moved together with the transport means.

The component storage unit is preferably subjected via the coupling means to compressed air, via which an air cushion arranged on the component storage unit is supplied. This is particularly advantageous when the assembly unit itself has at least one air cushion to be supplied with compressed air.

Two component storage units can be guided with the assembly unit so that after emptying one of the component storage units the second component storage unit is available for further components to be incorporated. The assembly unit can accordingly work continuously without interference caused by the equipping of the component storage unit with components and there is no break in production through the equipping process, in which the emptied component storage unit is equipped with components.

A sensor can be provided on the component storage unit and/or on the assembly unit, the sensor allowing detection of when the component storage unit is empty. The empty container can then be allowed back to an equipping station and be equipped again so that it is then available for the assembly unit again.

According to an advantageous embodiment of the invention, in which the handling means is mounted so as to float via a support means, the assembly unit comprises at least one force application means, by means of which the support means can subjected to a force counteracting the tilting. This is particularly advantageous when particularly heavy components are to be incorporated by means of the handling means. This is the case, for example, when the handling means is designed for a load of more than 200 kg, for example for a load of 240 kg. If the handling means lifts such a heavy component excessive tilting of the support means and thus high forces on the coupling or the vehicle body can be prevented through the force application means.

By way of force application means compensating cylinders can be used that press on the support means if it is tilted due to the heavy load held by the handling means. The compensating cylinders are preferably controlled in dependence upon the movement of the handling means. This can be achieved using a control means for controlling the handling means that communicates with a control means for controlling the assembly unit. The handling means can be balanced exactly in any state. It is thereby prevented that by means of coupling of the handling means to the workpiece undesirably high forces act on the workpiece. Undesirably high forces acting on a coupling unit that couples the handling means to the workpiece can also be prevented as a result of centre of gravity displacements of the handling means.

According to a further aspect of the invention the handling means can be designed for a load of no more than 50 kg. The assembly unit can thereby be designed to be particularly simple in technical terms and thus particularly cost-effective. This applies particularly when the handling means is designed for a load of no more than 20 kg, preferably no more than 16 kg. For example, simple air springs (bellows cylinders) can then be used for mounting the handling means on the transport means, said air springs (bellows cylinders) ensuring the floating support of the handling means.

In the case of such a handling means the robot can be used, in addition to the abovementioned fields of application, in a further possible application in coating processes, for example in cavity preservation, seam sealing and/or arrangement of plug elements within the scope of coating processes.

The features and feature combinations mentioned above in the description and the features and feature combinations mentioned below in the description of the figures and/or shown solely in the figures can be used not only in the respectively indicated combination but also in other combinations or alone without going outside of the scope of the invention.

Further advantages, features and details of the invention follow from the claims, the following description of preferred embodiments and by reference to the drawings, in which the same units or those with the same function have identical reference numerals.

### BRIEF DESCRIPTION OF THE DRAWING FIGURES

The drawings show:

FIG. 1 schematically, an assembly system with a conveyor belt and an assembly unit which can be freely moved independently of the conveyor belt;

FIG. 2 in an enlarged perspective detailed view, the assembly unit according to FIG. 1; and

FIG. 3 an alternative assembly unit that is particularly simple in technical terms.

### DETAILED DESCRIPTION

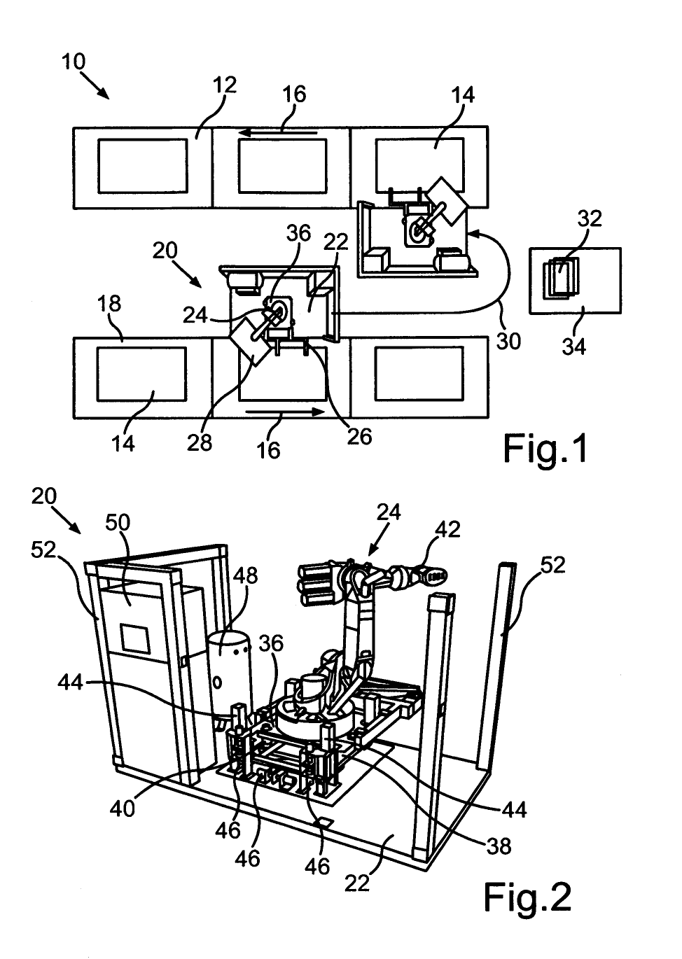

An assembly system 10 shown schematically in FIG. 1 comprises a conveyor belt 12, which in the present case comprises, for example, push platforms, and which moves vehicle bodies 14 in a conveying direction 16. A second conveyor belt 18 has the same structure but it conveys the vehicle bodies 14 in an opposite conveying direction 16.

An assembly unit 20 comprises a transport platform 22, on which an industrial robot 24 is mounted so that it floats. The industrial robot 24 is coupled mechanically to the vehicle body 14 by means of a coupling part 26. If the conveyor belt 18 moves the vehicle body 14 in the conveying direction 16, the assembly unit 20 is also moved in the same conveying direction. The industrial robot 24 can move in all degrees of freedom relative to the transport platform 22 due to the floating support.

The industrial robot 24 is designed for assembling a glazed component 28 on the vehicle body 14. For example, by means of the industrial robot 24 a sliding roof, in particular an externally running sliding roof, and/or a front windscreen can be positioned on the vehicle body 14 and/or fixed to the vehicle body 14. The industrial robot 24 can be designed for a load of over 200 kg, in particular for a load of up to 240 kg. If the industrial robot 24 is designed for such a load in the assembly of a panoramic glass roof on the vehicle body 14 by means of the assembly unit 20 is facilitated.

If the industrial robot 24 is again decoupled from the vehicle body 14, after assembly of the component to be assembled on the vehicle body 14, the industrial robot 24 can be brought by means of the transport platform 22 to any desired further place of use. The transport platform 22 can be moved independently of the conveyor belt 12, 18 and without the use of rails. This produces great flexibility during use of the assembly unit 20. A possible non-rail-based movement path 30 of the assembly unit 20 is shown by way of example in FIG. 1.

In the case of this assembly unit 20 the movement of the transport platform 22 can take place, for example, by means of an air cushion with a friction wheel drive arranged below the transport platform 22. Alternatively, for example, an electric drive can be used as a drive that can be synchronized to the speed of the conveyor belt 12, 18. As the industrial robot 24 is mounted in the coupled state through, for example, two double bellows cylinders acting in the conveying direction relative to the transport platform 22 a simple synchronization of the platform drive with the conveying means within the floating region of the industrial robot 24 to the transport platform 22 can be realised.

Different driverless systems can be used to autonomously bring the assembly unit 20 to its desired place of use, such as a GPS control, a control by means of coils laid in the ground or similar systems that allow remote control from externally. If the industrial robot 24 is to carry out different handling steps on the first conveyor belt 12 from those on the second conveyor belt 18, components 32 to be incorporated on the first conveyor belt 12 can be received at a material station 34 as it travels past. Additionally or alternatively a component storage unit (not shown) is coupled to the assembly unit 20 and can be brought with it to its place of use.

As follows in particular from FIG. 2 the industrial robot 24 is rigidly and fixedly connected to a support plate 36. The support plate 26 can be adjusted in height relative to a base plate 38. For this purpose adjusting cylinders 40 are provided between the support plate 36 and the base plate 38. If a particularly heavy glazed component 28—for example the panoramic glass roof for the vehicle body 14—is held on a robotic arm 42 of the industrial robot 24, compensating cylinders 44 ensure that the support plate 36 is at best slightly tilted. For this purpose the compensating cylinders 44 apply a force to the base plate 38 that balances out the weight force of the heavy glazed component 28. The base plate 38 is furthermore connected to pairs of shock absorbers 46 that prevent jerky movements of the industrial robot 24 through their damping effect.

The assembly unit 20 is equipped with further modules that ensure its autonomy, for example a pressure storage reservoir 48 for compressed air and a robot control 50. Railings can be arranged on supports 52 of the assembly unit 20 in order to protect workers and in order to ensure mobile fencing-in of the assembly unit 20. Alternatively the transport platform 22 can be surrounded by a protecting cage comprising rollers and open only towards the conveyor belt 12, 18, the protecting cage being moved with the assembly unit 20 upon movement thereof. In this way the whole region in which the assembly unit 20 moves no longer needs to be fenced in, in order to prevent workers from reaching a movement region of the industrial robot 24.

By means of the assembly unit 20 designed for heavy loads, modules can be incorporated that are used in alternative vehicle drives. These can be energy storage units, for example a traction battery for an electric vehicle and/or a hybrid vehicle. A so-called plug in battery can have a weight of 150 kg.

Furthermore, the assembly unit 20 can be designed for assembly of a power generator, for example a fuel cell stack, on the vehicle body 14. Such a fuel cell stack can have a weight of 80 kg.

The assembly unit 20 is furthermore preferably designed for transport and implementation of test systems, as are used in the production of vehicles with alternative drives. For example, a complete test system for carrying out a sealing test of hydrogen pipes and for checking tank pressure in a fuel cell vehicle can be brought to its place of use by means of the assembly unit 20. The industrial robot 24 can hereby check whether hydrogen gas is escaping from the pipe system. A test system, by means of which the pipe system of a fuel cell system and/or associated cooling medium pipes can be flushed, can also be transported by means of the assembly unit.

Further fields of application of the assembly unit 20 comprise, in the field of the internal fitting-out of the vehicle body 14, the assembly of a modular roof, the incorporation of damping mats, the incorporation of a spare wheel well, a cockpit, a front module, windows, seats and similar components. In addition, the assembly unit 20 can be used in coating processes, for example in cavity preservation, seam sealing and/or the incorporation of auto-pads or plug elements.

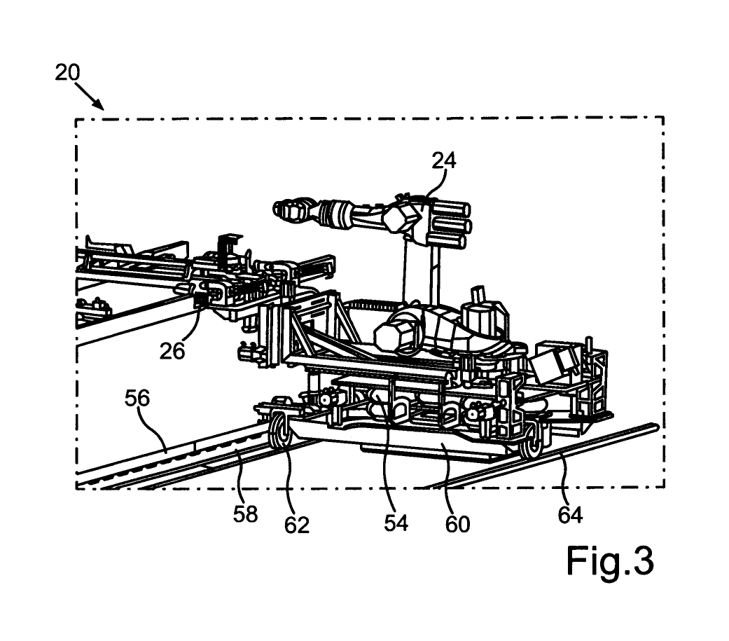

FIG. 3 shows an alternative, particularly cost-effective embodiment of an assembly unit 20 designed for small loads. As the industrial robot 24 in this embodiment is designed merely for handling loads of up to 16 kg, the robot has a comparatively low weight and the floating support of the industrial robot 24 can be designed correspondingly simply. In the present case the industrial robot 24 is mounted on cost-effective and simple double bellows cylinders 54. Movements of the vehicle body 14 in all degrees of freedom can thereby be followed if the assembly unit 20 is rigidly connected via the coupling component 26 to the vehicle body 14.

In the variant of the assembly unit 20 shown in FIG. 3, which is technically simple and compact as well as cost-effective, the assembly unit 20 is guided on a rail 56 that can comprise a toothed rod 58. Alternatively a friction wheel drive can be provided. A chassis 60 of the assembly unit 20 comprises low-friction wheels 62 which are guided on rails 64. The wheels 62 can be produced from a thermoplastic, for example from polyoxymethylene (POM). A pressure accumulator is furthermore integrated into the chassis 60 for application of compressed air to the double bellows cylinder 54.

The assembly unit 20 shown in FIG. 3 can be advantageously used due to its compact dimensions in door preassembly, thus during fitting of a vehicle door with windows, window regulators, paneling parts and similar door modules.

Due to the low weight of the assembly unit 20 shown in FIG. 3, when screwing on door modules, the assembly unit 20 can be coupled to a door suspension that carries the vehicle door to be fitted. If the industrial robot 24 breaks down, the assembly unit 20 can be easily pushed to one side manually by a worker and the assembly of the door module can be carried out at the same station by the worker.

The compact assembly unit 20 according to FIG. 3 can furthermore be used in during cavity preservation. The assembly unit 20 shown in FIG. 3 can also be provided with a protective cage which ensures great safety during use.

The disclosed assembly units 20 facilitate optimum exploitation of production halls and stations by avoiding buffer stretches. In addition, flexible work by workers and industrial robots 24 on the same vehicle is facilitated. Automated processes can be easily displaced along the production line. No cyclical belt sections are necessary for continuous flow production.

The modular assembly system provided by the assembly unit 20 facilitates flexible adaptation of the technology to individual tasks. In addition universal use having regard to process requirements and the place of application, which can also be a platform, is ensured. The possible preliminary implementation ensures a short integration period on the production line. In particular, the assembly unit 20 can be used in the field of modular vehicle structures.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-7. (canceled)

8. An assembly unit, comprising:
handling means for handling a workpiece in the form of a vehicle body, which can be moved in a conveying direction through coupling to the workpiece;
conveying means for conveying the workpiece; and
transport means for transporting the handling means, wherein the transport means is configured to move independently of the conveying means and without use of rails when the handling means is decoupled from the workpiece.

9. The assembly unit according to claim 8, wherein the handling means is mounted via a support means so that it floats, wherein the assembly unit comprises at least one force application means for applying a force counteracting a tilting of the support means.

10. The assembly unit according to claim 8, wherein the handling means is configured for assembly of a glazed component on the vehicle body, the glazed component is a panoramic glass roof or a front windscreen.

11. The assembly unit according to claim 8, wherein the handling means is configured to assemble an energy generator or an energy accumulator on the vehicle body, the energy generator is a fuel cell stack and the energy accumulator is a traction battery.

12. The assembly unit according to claim 8, wherein the assembly unit is configured to transport of a test system for a fuel of a fuel cell system, by means of which a pipe system can be tested.

13. An assembly unit, comprising:
handling means for handling a workpiece in the form of a vehicle body, which can be moved in a conveying direction through coupling to the workpiece;
conveying means for conveying the workpiece; and
transport means for transporting the handling means, wherein the transport means comprises a coupling means for coupling at least one component storage unit that is moveable with the transport means when coupled to the transport means.

14. The assembly unit according to claim 13, wherein the handling means is mounted via a support means so that it floats, wherein the assembly unit comprises at least one force application means for applying a force counteracting a tilting of the support means.

15. The assembly unit according to claim 13, wherein the handling means is configured for assembly of a glazed component on the vehicle body, the glazed component is a panoramic glass roof or a front windscreen.

16. The assembly unit according to claim 13, wherein the handling means is configured to assemble an energy generator or an energy accumulator on the vehicle body, the energy generator is a fuel cell stack and the energy accumulator is a traction battery.

17. The assembly unit according to claim 13, wherein the assembly unit is configured to transport of a test system for a fuel of a fuel cell system, by means of which a pipe system can be tested.

18. An assembly unit, comprising:
handling means for handling a workpiece in the form of a vehicle body, which can be moved in a conveying direction by coupling to the workpiece;
conveying means for conveying the workpiece; and
transport means for transporting the handling means, wherein the handling means is configured for a load of no more than 50 kg.

19. The assembly unit of claim 18, wherein the transport means is configured for a load of no more than 20 kg.
